(19) United States
(12) Patent Application Publication
(10) Pub. No.: US 2008/0285066 A1
(43) Pub. Date: Nov. 20, 2008

(54) Image processor and image processing method

(76) Inventor: Yuzo Oshima, Tokyo (JP)

Correspondence Address: IPUSA, P.L.L.C, 1054 31ST STREET, N.W., Suite 400, Washington, DC, 20007, US

(21) Appl. No.: 12/149,280

(22) Filed: Apr. 30, 2008

(30) Foreign Application Priority Data
May 15, 2007 (JP) 2007-129697

(51) Int. Cl. G06F 17/00

(52) U.S. Cl. 358/1.13

(57) ABSTRACT

An image processor is disclosed that includes an input part to which image data to be subjected to image processing are input; an input control part configured to control the inputting of the image data to the input part; an output part configured to output the result of the image processing; an output control part configured to control the outputting of the image data from the output part; and a processing control part configured to control processing of the image data, the processing control part being to be connected between the input control part and the output control part through multiple transmission parts. The processing control part is connected to one of the transmission parts which one transmission part is subsequent to the input control part when the output setting of the image data output from the output part is changed.

### BACKGROUND OF THE INVENTION

1. Field of the Invention

The present invention relates to an image processor and an image processing method.

2. Description of the Related Art

In recent years, image processors such as printers, copiers, scanners, facsimile machines, and multifunction machines that implement the functions of the above-mentioned apparatuses in a single enclosure have a central processing unit (CPU) like general-purpose computers, and implement their functions through control by applications.

For example, according to an image forming apparatus shown in Japanese Patent No. 3679349, functions shared by an application are provided as a platform, and it is possible to implement an application using the API (Application Programming Interface) of the platform. According to this image forming apparatus, in which the shared functions are provided as a platform, redundant implementation of the shared functions in each application is avoided, so that it is possible to increase the efficiency of development of the applications.

According to this configuration, however, unless the functions or interfaces provided by this platform are designed with appropriate granularity, the efficiency of development of applications may not be increased more than expected.

For example, if the granularity is too high, even an application providing a simple service requires a large number of API calls and has a complicated source code.

On the other hand, if the granularity is too low, it is necessary to modify the internal configuration of the platform so that the number of man-hours for development may increase in the case of implementing an application that provides a service different in part from a certain function. In particular, if the modules in the platform highly depend on one another, it may be necessary to not only add a new function to but also modify the existing part of the platform, thus resulting in increased complication.

Further, in the case of implementing an application in which part of the service provided by an existing application (for example, image inputting) is changed, it is not possible to call the existing application for a part other than the changed part. Accordingly, source code should be newly written to implement a new application.

### SUMMARY OF THE INVENTION

Embodiments of the present invention may solve or reduce one or more of the above-described problems.

According to one embodiment of the present invention, an image processor and an image processing method are provided in which one or more of the above-described problems may be solved or reduced.

According to one embodiment of the present invention, an image processor and an image processing method capable of customizing or expanding functions in a simplified manner are provided.

According to one embodiment of the present invention, an image processor is provided that includes an input part to which image data to be subjected to image processing are input; an input control part configured to control the inputting of the image data to the input part; an output part configured to output a result of the image processing; an output control part configured to control the outputting of the image data from the output part; and a processing control part configured to control processing of the image data, the processing control part being to be connected between the input control part and the output control part through a plurality of transmission parts, wherein the processing control part is connected to one of the transmission parts which one transmission part is subsequent to the input control part when an output setting of the image data output from the output part is changed.

According to one embodiment of the present invention, an image processing method is provided that includes the steps of (a) controlling inputting of image data to be subjected to image processing to an input part; (b) controlling outputting of the image data from an output part configured to output a result of the image processing; and (c) controlling processing of the image data, wherein step (c) is performed between step (a) and step (b) when an output setting of the image data output from the output part is changed.

According to one aspect of the present invention, it is possible to simplify customization or expansion of a function.

### BRIEF DESCRIPTION OF THE DRAWINGS

Other objects, features and advantages of the present invention will become more apparent from the following detailed description when read in conjunction with the accompanying drawings, in which:

FIG. 1 is a diagram for illustrating the concept of “pipes and filters”;

FIG. 2 is a diagram showing a software configuration of an image processor according to a first embodiment of the present invention;

FIG. 3 is a diagram for illustrating printing in the image processor according to the first embodiment of the present invention;

FIG. 4 is a diagram for illustrating processing in the case where there is a change in an output setting according to the first embodiment of the present invention;

FIG. 5 is a diagram showing a software configuration of an image processor according to a second embodiment of the present invention;

FIG. 6 is a diagram for illustrating previewing in the image processor according to the second embodiment of the present invention;

FIG. 7 is a diagram for illustrating an operation at the time of performing previewing in the image processor according to the second embodiment of the present invention;

FIG. 8 is a diagram for illustrating previewing corresponding to the output setting in the image processor according to the second embodiment of the present invention;

FIG. 9 is a diagram for illustrating management of job lines in the image processor according to the second embodiment of the present invention;

FIG. 10 is a diagram for illustrating the case of executing an active job line in the image processor according to the second embodiment of the present invention;

FIG. 11 is a diagram for illustrating preview image switching in the image processor according to the second embodiment of the present invention;

FIG. 12 is a diagram for illustrating the case where the output setting is changed after a REVERSE instruction in the image processor according to the second embodiment of the present invention;

FIG. 13 is a diagram for illustrating the case of retaining image data in an image pipe subsequent to a processing filter according to the second embodiment of the present invention;

FIG. 14 is a diagram showing the case where preview images before and after the change of the output setting are displayed in the operations part of the image processor according to the second embodiment of the present invention; and

FIG. 15 is a diagram for illustrating a recording medium on which is recorded a program for causing one or more of functions described in the first and second embodiments to be implemented according to the present invention.

### DETAILED DESCRIPTION OF THE PREFERRED EMBODIMENTS

A description is given below, with reference to the accompanying drawings, of embodiments of the present invention.

According to one aspect of the present invention, customization or expansion of functions is simplified by applying a software architecture based on the idea called “pipes and filters” to an image processor. Further, according to one aspect of the present invention, if there is a change in the output setting of image data to be output from the image processor, a processing filter is connected to a pipe at the stage subsequent to an input filter, thereby processing and outputting the image data in accordance with the output setting.

Further, according to the image processor of the present invention, a preview filter that outputs a preview image is provided, and if there is a change in the output setting, the preview filter is connected to the processing filter, thereby causing a preview image corresponding to the output setting to be displayed. According to the image processor of the present invention, the jobs to be executed in the processing filter and the preview filter are retained in correspondence to the output setting, thereby switching and displaying a preview image every time the output setting is changed.

### First Embodiment

First, a description is given below, prior to a first embodiment, of the concept of “pipes and filters” applied to an image processor according to the present invention.

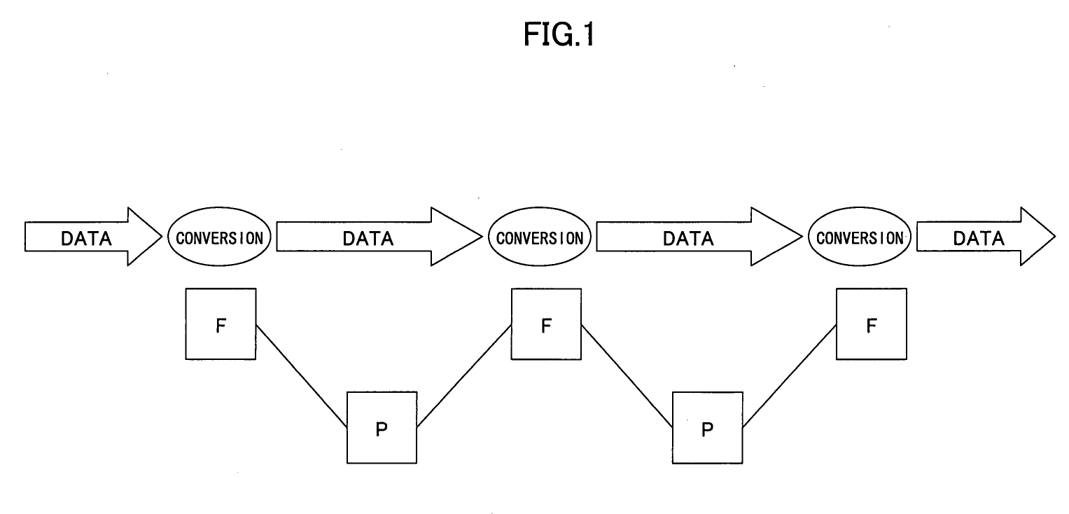

FIG. 1 is a diagram for illustrating the concept of “pipes and filters”. In FIG. 1, “P” shows a pipe and “F” shows a filter.

The filter is a program that performs predetermined processing on input data and outputs the result of the processing. The pipe connects filters. The pipe temporarily retains the processing result output from the filter connected to the input side of the pipe, and thereafter, transmits data to the filter connected to the output side of the pipe. Thus, according to the concept of “pipes and filters,” the processing in filters can be successive through a pipe.

In this embodiment, predetermined processing performed in a filter is considered to be processing that performs predetermined conversion on input data. That is, in the image processor of this embodiment, each implemented function is taken as a succession of “conversions” of a document (data). Each function of the image processor is considered to be configured by inputting, processing, and outputting of a document, that is, data. Therefore, in this embodiment, each of “inputting,” “processing,” and “outputting” is taken as “conversion,” and a software component that implements one “conversion” is configured as a filter.

According to this embodiment, a filter that controls inputting of data is an input filter, a filter that controls processing of data is a processing filter, and a filter that controls outputting of data is an output filter. Each of these filters is an independent program, and there is no dependency between filters. Accordingly, each filter can be added (installed) or deleted (uninstalled) independently on a filter-by-filter basis in the image processor.

A description is given below of an image processor 100 according to the first embodiment of the present invention.

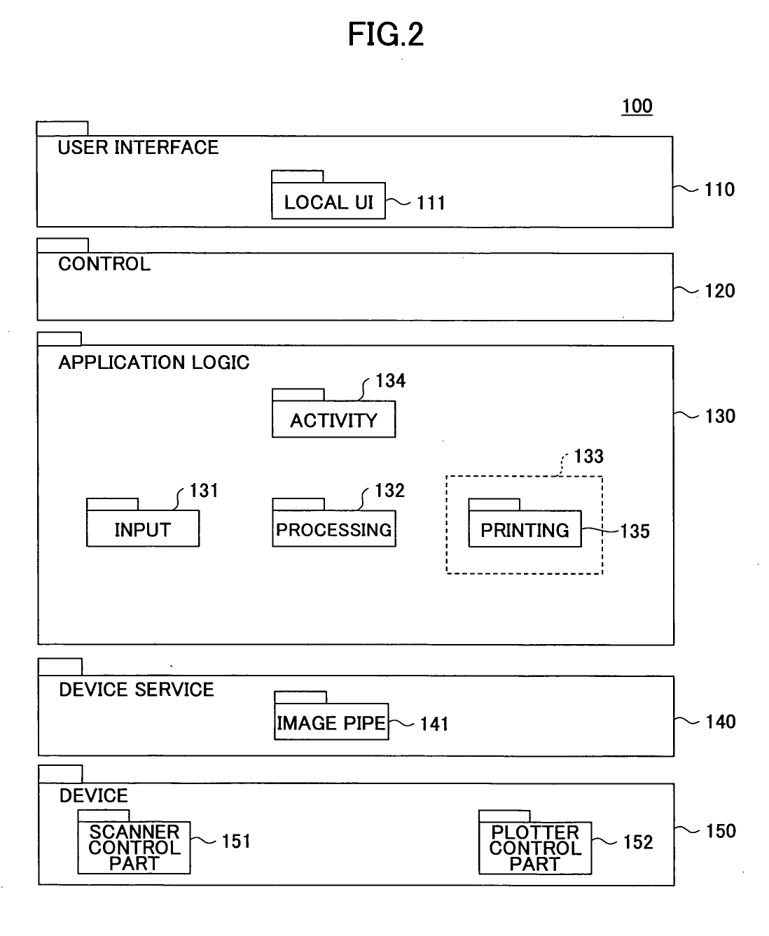

FIG. 2 is a diagram showing a software configuration of the image processor 100 according to the first embodiment of the present invention.

The image processor 100 is, for example, a multifunction machine that implements multiple functions such as printing, copying, scanning, and facsimile in a single enclosure.

The software implementing the functions of the image processor 100 has a hierarchical structure formed of a user interface layer 110, a control layer 120, an application logic layer 130, a device service layer 140, and a device layer 150. The hierarchical relationship among these layers 110 through 150 is based on the interlayer calling relationship. That is, an upper layer calls a lower layer in FIG. 2.

In the image processor 100, when a user gives an instruction to execute a function with the user interface layer 110, the user interface layer 110 calls the control layer 120 to control the application logic layer 130 based on the execution instruction. In the application logic layer 130, an application that causes the requested function to be implemented is executed based on the instruction from the control layer 120. Then, the device service layer 140 and the device layer 150 control one or more hardware resources of the image processor 100 based on the result of the execution. In the image processor 100, a result corresponding to the function received by the user interface layer 110 is output by these operations.

A description is given below of each of these layers 110 through 150.

The user interface layer 110, in which, for example, a local UI (User Interface) part 111 is implemented, has the function of accepting execution instructions for implementing various functions of the image processor 100. The “various functions” include a copying function, a printing function, a scanning function, and a facsimile function. The local UI part 111 may be provided in, for example, an operations part (not graphically illustrated) where operations for processing executed in the image processor 110 are performed. The operations part may be implemented by, for example, an operations panel with a display area. The execution instructions accepted in the user interface layer 110 are transmitted to the control layer 120.

In the control layer 120, there is implemented a function for controlling processing that implements various functions of the image processor 100. Specifically, the control layer 120 has the function of connecting filters in the application logic layer 130 in accordance with a requested function and controlling the execution of the function using the connected filters. A function of the image processor 100 described below in this embodiment is the definition of a single unit of service (from inputting of a request to acquisition of a final output) provided to a user by the image processor 100, and in terms of software, has the same meaning as an application that provides a single unit of service.

In the application logic layer 130, various filters are implemented that are a group of components implementing some of the functions provided in the image processor 100. In the application logic layer 130, multiple filters are combined to implement a single function by the control of the control layer 120. According to this embodiment, an input filter 131 (an input control part), a processing filter 132 (a processing control part), an output filter 133 (an output control part), and an activity 134 are implemented in the application logic layer 130. The filters 131 through 133 implemented in the application logic layer 130 operate based on the same definition and are controlled by the control layer 120 based on this definition. A description is given below of the details of each of the filters 131 through 133. The activity 134 is a component that manages execution of the filters 131 through 133.

In the device service layer 140, there is implemented a lower function shared by the filters 131 through 133 implemented in the application logic layer 130. According to this embodiment, an image pipe 141 (a transmission part) is implemented in the device service layer 140. The image pipe 141 implements the above-described function of a pipe, and transmits the output result of one of the filters 131 through 133 to another one of the filters 131 through 133 implemented in the application logic layer 130. Here, the image pipe 141 may connect, for example, the input filter 131 and the processing filter 132 or the processing filter 132 and the output filter 133.

In the device layer 150, there are implemented drivers that are programs controlling hardware. According to this embodiment, for example, a scanner control part 151 and a plotter control part 152 are implemented in the device layer 150. The control parts 151 and 152 control devices that appear in their names, that is, a scanner and a plotter, respectively.

A description is given below of the filters 131 through 133 implemented in the application logic layer 130.

According to this embodiment, the input filter 131 controls the inputting of data input from outside the image processor 100. The input filter 131 includes, for example, a reading filter, a mail reception filter, a facsimile reception filter, and a PC document reception filter (not graphically illustrated). The reading filter, for example, controls reading of image data by the scanner and outputs the read image data. The mail reception filter receives electronic mail in the image processor 100 and outputs data contained in the received electronic mail. The facsimile reception filter controls facsimile reception and outputs received data. The PC document reception filter receives printing data from a client PC (not graphically illustrated) and outputs the printing data.

The processing filter 132 of this embodiment performs predetermined processing on image data input from a filter on the input side of the processing filter 132, and outputs the processing result to a filter on the output side of the processing filter 132. The processing of this embodiment includes, for example, editing of image data such as combining, enlarging, reducing, and rotating input data.

According to this embodiment, the output filter 133 controls outputting of input data and outputs the input data. The output filter 133 includes a printing filter 135. In addition to the printing filter 135, the output filter 133 includes, for example, a mail transmission filter, a facsimile transmission filter, and a PC document transmission filter (not graphically illustrated).

The printing filter 135 causes the plotter control part 152 to output (print out) input data. With respect to other filters contained in the output filter 133, for example, the mail transmission filter transmits data as an attachment to electronic mail. The facsimile transmission filter transmits input data by facsimile. The PC document transmission filter transmits input data to a client PC (not graphically illustrated). In the following description, processing executed in each filter is referred to as a job.

According to this embodiment, an instruction input through the local UI part 111 in the user interface layer 110 is transmitted to the activity 134 through the control layer 120. The activity 134 controls execution of jobs in the input filter 131, the processing filter 132, and the output filter 133 in accordance with the instruction.

In the application logic layer 130, the functions of the image processor 100 are implemented by combining the above-described filters. According to this configuration, it is possible to implement various functions by combining filters and pipes in the image processor 100. Specifically, for example, in the case of implementing the copying function, the reading filter contained in the input filter 131, the processing filter 132, and the printing filter 135 may be combined.

A description is given below of printing in the image processor 100 according to this embodiment.

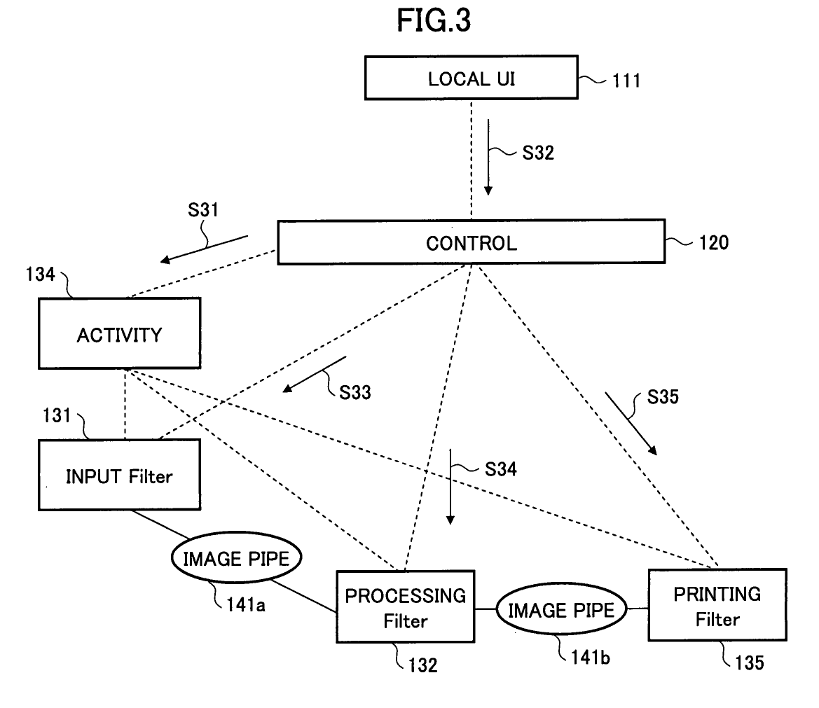

FIG. 3 is a diagram for illustrating printing in the image processor 100 according to the first embodiment of the present invention.

In the image processor 100 of this embodiment, first, in step S31, the control layer 120 instructs the activity 134 to execute a job generated in each filter. In the image processor 100 of this embodiment, the instruction from the control layer 120 to the activity 134 may be given, for example, when the operation of a function such as the copying function is selected by a user or when an instruction to execute the function in the image processor 100 is given (that is, when a START button is pressed) by a user. Alternatively, the instruction from the control layer 120 to the activity 134 may be given when the image processor 100 is turned on.

Next, in step S32, when the local UI part 111 generates a request to execute printing, the local UI part 111 transmits this request to the control layer 120. In the case illustrated in FIG. 3, it is assumed that copying, which is one example of printing, is selected. In this case, the operation of giving an instruction to read and print paper original material such as a paper document is performed in the local UI part 111.

In response to reception of the instruction to read and print the paper document, the control layer 120 connects the input filter 131, the processing filter 132, and the printing filter 135 with image pipes 141a and 141b. At this point, in practice, the reading filter contained in the input filter 131 is connected to the processing filter 132. In step S33, the control layer 120 causes the input filter 131 to generate a job to be executed by the input filter 131. In step S34, the control layer 120 causes the processing filter 132 to generate a job to be executed by the processing filter 132. In step S35, the control layer 120 causes the printing filter 135 to generate a job to be executed by the printing filter 135.

When the job to be executed is generated in each of the filters 131, 132, and 135, the activity 134 instructs each of the filters 131, 132, and 135 to execute the corresponding job. Then, the input filter 131 causes the scanner part that is an input part to read the paper document, so that the paper document is read as image data. The image data are output from the input filter 131 to be transmitted to the processing filter 132 through the image pipe 141a.

The processing filter 132 performs preset predetermined processing on the image data, and outputs the processed image data. Next, the processed image data are transmitted to the printing filter 135 that is an output filter. The printing filter 135 performs the operation of causing the processed image data to be output from the plotter part that is an output part. The image processor 100 of this embodiment performs copying in this manner.

According to the image processor 100 of this embodiment, if there is a change in the output setting of image data in printing and outputting the image data using the printing filter 135, the processing filter 132 is connected to the image pipe 141a at the stage subsequent to the input filter 131. A description is given below of the case where there is a change in the output setting of image data.

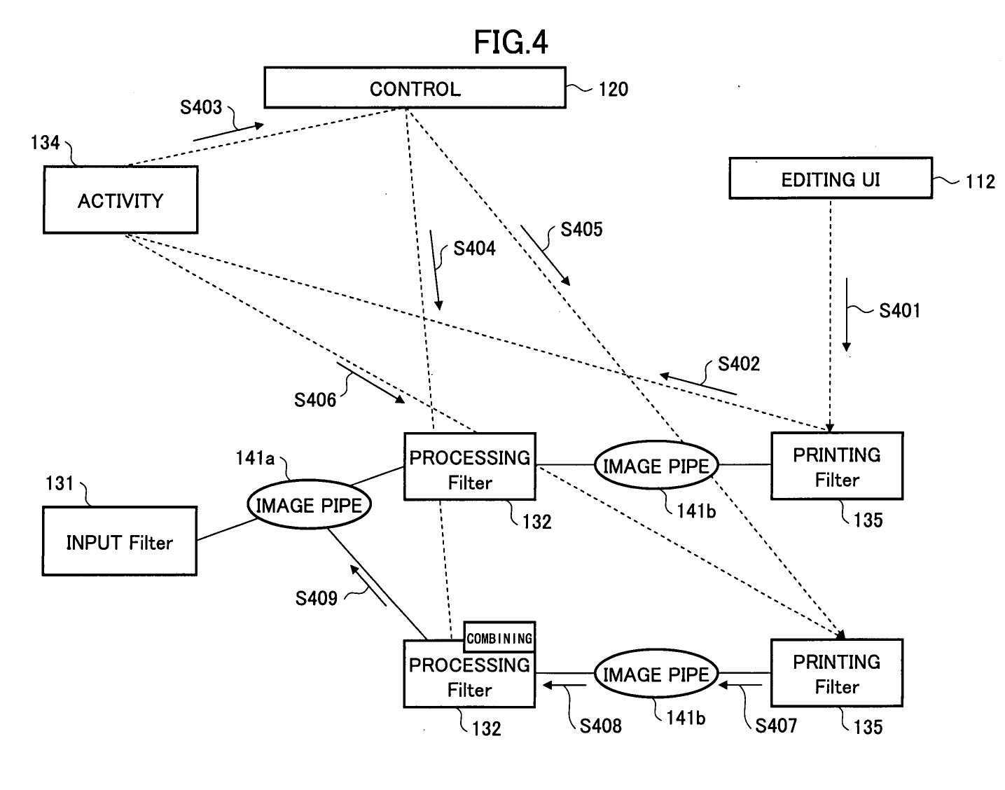

FIG. 4 is a diagram for illustrating processing in the case where there is a change in the output setting in the first embodiment. In FIG. 4 and the following drawings, each filter described with the term “Filter” in the corresponding box may indicate a job to be executed generated in the filter.

Referring to FIG. 4, when the output setting of image data is changed in an editing UI (User Interface) 112 in step S401, the control layer 120 causes the processing filter 132 to be connected to the image pipe 141a. The editing UI 112 determines the output setting at the time of printing and outputting image data in the image processor 100. The editing UI may be included in the local UI part 111. In the following description, the output setting is, for example, combining, enlarging, reducing, or rotating image data, which is a printing condition enabled by processing on image data in the processing filter 132.

In step S402, the printing filter 135 notifies the activity 134 of reception of the instruction to change the output setting. In response to the notification from the printing filter 135, in step S403, the activity 134 requests the control layer 120 to generate jobs corresponding to the change in the output setting. In response to reception of the job generation request, in step S404, the control layer 120 causes the processing filter 132 to generate a job corresponding to the change in the output setting. Further, in step S405, the control layer 120 causes the printing filter 135 to generate a job corresponding to the change in the output setting.

The job corresponding to the output setting is for causing image data to be printed out with the output setting changed (updated) in step S401. Specifically, for example, in the case where the output setting is changed from a regular printing setting to a combination setting to combine two pages into one sheet, the processing filter 132 generates a job to combine two pages' worth of image data read from the image pipe 141a into a single sheet in step S404. Further, the printing filter 135 generates a job to print out the combined image data read from the image pipe 141b in step S405.

In response to the generation of the jobs in the processing filter 132 and the printing filter 135, in step S406, the activity 134 instructs the printing filter 135 to execute the job.

In response to reception of this execution instruction, in step S407, the printing filter 135 issues a request to read image data to the image pipe 141b. At this point, the image pipe 141b retains no image data. Accordingly, in step S408, the image pipe 141b transmits this read request to the processing filter 132. In response to reception of this read request, in step S409, the processing filter 132 reads image data from the image pipe 141a. Then, the processing filter 132 executes the job of processing the read image data, and outputs the processed image data to the image pipe 141b.

Here, the printing filter 135 continues to issue the read request to the image pipe 141b until the printing filter 135 reads image data. Accordingly, the processed image data output from the processing filter 132 are read by the printing filter 135 through the image pipe 141b. The printing filter 135 reads the processed image data from the image pipe 141b and causes the processed image data to be printed out.

According to this embodiment, when there is a change in the output setting as described above, it is possible to output image data corresponding to the change in the output setting with ease by causing the processing filter 132 to be connected to the image pipe 141a subsequent to the input filter 131.

Further, retaining a job generated in correspondence to the output setting in each of the processing filter 132 and the printing filter 135 makes it possible to easily perform printing and outputting corresponding to the output setting without performing inter-job control by executing the jobs corresponding to the output setting in the filters 132 and 135.

### Second Embodiment

A description is given below of a second embodiment of the present invention.

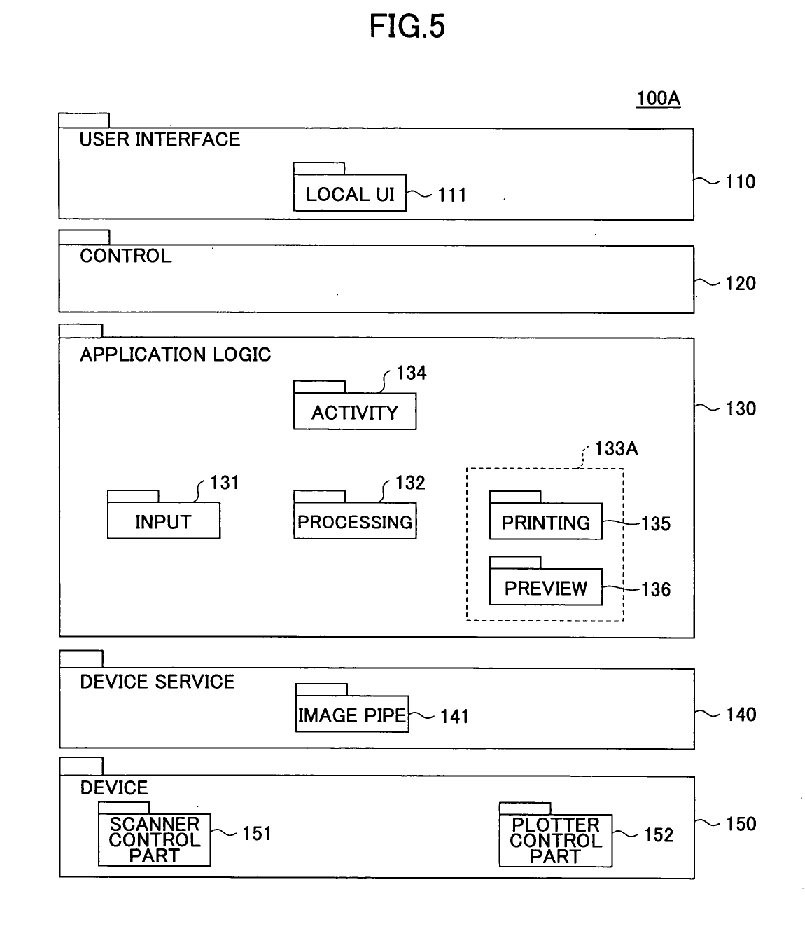

FIG. 5 is a diagram showing a software configuration of an image processor 100A according to the second embodiment of the present invention.

The image processor 100A according to the second embodiment is different from the image processor 100 of the first embodiment in that an output filter 133A contains a preview filter 136 (a preview control part). In the following description, the elements having the same functional configuration as those described in the first embodiment are referred to by the same reference numerals, and a description thereof is omitted.

Referring to FIG. 5, the output filter 133A of the image processor 100A includes the preview filter 136 in addition to the printing filter 135. The preview filter 136 causes input image data to be previewed. The preview image data output from the preview filter 136 may be displayed, for example, on the operations part of the image processor 100.

According to the image processor 100A, by managing jobs executed for each output setting in the processing filter 132 and the preview filter 136, it is possible to display a preview image of output image data corresponding to the output setting at the time of printing out the image data.

Next, a description is given of previewing image data in the image processor 100A according to this embodiment. In the image processor 100A of this embodiment, when an instruction to preview image data is given, the function of previewing the image data is implemented without changing existing components by connecting the preview filter 136 included in the output filter 133A to the processing filter 132.

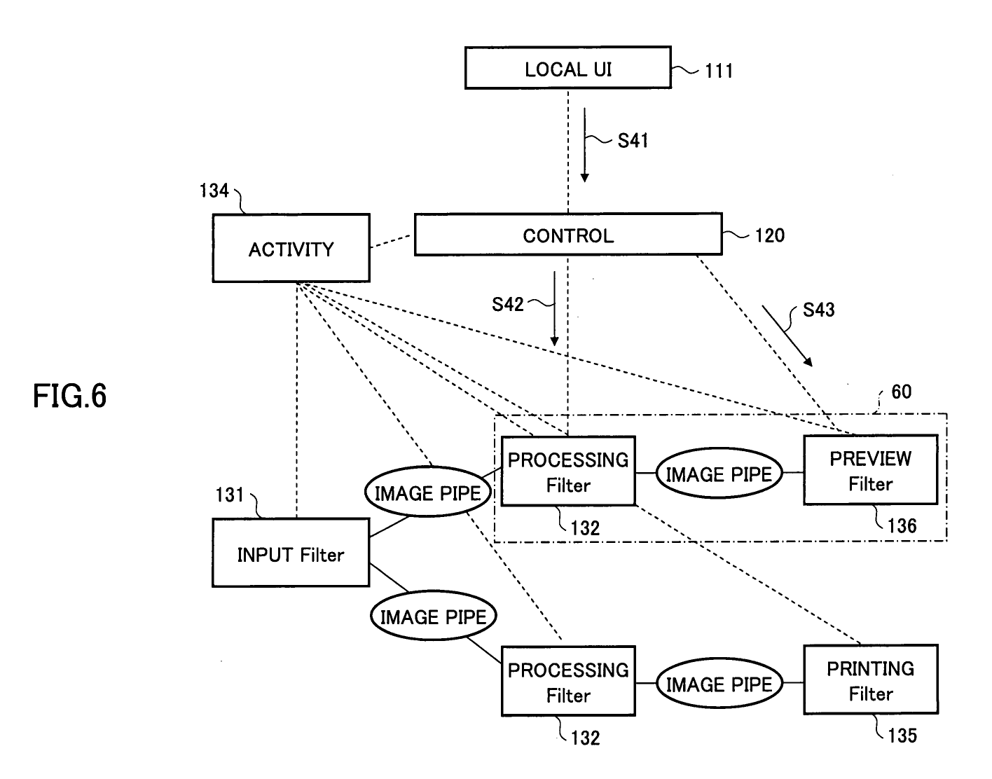

A description is given below, with reference to FIG. 6, of implementation of the preview function in the image processor 100A according to this embodiment.

FIG. 6 is a diagram for illustrating previewing in the image processor 100A of the second embodiment.

In the image processor 100A, when an instruction to preview output image data is given with the local UI 111, in step S41, the local UI 111 transmits this instruction to the control layer 120.

In response to reception of this instruction, the control layer 120 connects the preview filter 136 to the processing filter 134 through an image filter. Then, in step S42, the control layer 120 causes the processing filter 134 to generate a job to be executed in the processing filter 134 in order to generate image data to be output to the preview filter 136. Further, in step S43, the control layer 120 causes the preview filter 136 to generate a job to implement the preview function.

In response to the generation of the job to implement the preview function, the activity 134 instructs the preview filter 136 to execute the job. The preview filter 136 transmits this execution instruction to the processing filter 132 through the image pipe. In response to reception of this transmission, the processing filter 132 executes the job generated in the processing filter 132, and outputs the processed image data. The preview filter 136 outputs the processed image data as a preview display image.

According to this embodiment, the jobs executed in the processing filter 132 and the preview filter 136 are considered as a sequential job flow, and this job flow is referred to as a job line 60. According to this embodiment, the generated job line 60 is stored and retained in a below-described memory. Further, the preview image data output from the preview filter 136 may be displayed on the operations part (not graphically illustrated) provided with the local UI 111 and having a display part. A detailed description is given below of the operations part.

Here, the job generated in the processing filter 132 in step S42 is the same as the job generated in step S34 of FIG. 3. Accordingly, the processing filter 132 performs the same processing as in the case of copying described with reference to FIG. 3. That is, the processing filter 132 may execute a job generated based on an instruction from the control layer 120 according to an execution instruction from the activity 134, irrespective of whether the processing is copying or previewing.

Thus, according to the image processor 100A of this embodiment, by connecting the preview filter 136 to the processing filter 132, it is possible to implement the preview function without changing the processing filter 132 or other existing filters. That is, it is possible to simplify customization or expansion of a function.

Further, ever constant behavior of the processing filter 132 makes it possible to provide the preview filter 136 with the same image data as the image data provided to the printing filter 135. As a result, it is possible to preview image data of the same level, for example, in image quality, as output image data.

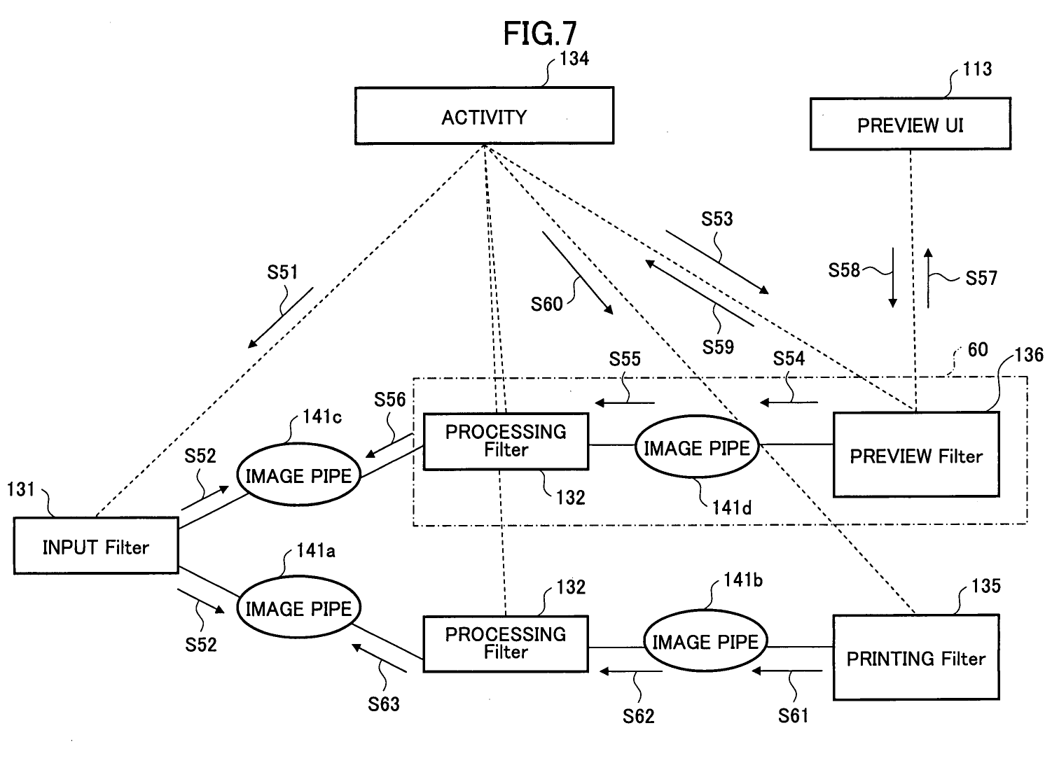

Here, a description is given in detail, with reference to FIG. 7, of an operation in the case where a printing instruction is given after a preview instruction in the image processor 100A of this embodiment.

FIG. 7 is a diagram for illustrating an operation at the time of performing previewing in the image processor 101A of the second embodiment.

When an instruction is given to preview output image data in the local UI 111, the control layer 120 causes the processing filter 132 and the preview filter 136 to generate jobs to be executed therein (the job line 60). In response to the generation of the jobs in the processing filter 132 and the preview filter 136, in step S51, the activity 134 instructs the input filter 131 to execute the processing of reading (inputting) image data.

In response to this instruction, the input filter 131 executes processing for reading image data to be subjected to image processing. The processing executed herein corresponds to the job generated in the input filter 131 based on the instruction from the control layer 120. When the image data are read, in step S52, the input filter 131 outputs the read image data to the image pipe 141a and an image pipe 141c. Here, the same image data are output to the image pipe 141a and the image pipe 141c.

When the image data are read by the input filter 131, in step S53, the activity 134 causes the preview filter 136 to preview the image data. The previewing performed herein corresponds to the job generated in the preview filter 136 based on the instruction from the control layer 120.

In response to reception of this instruction, in step S54, the preview filter 136 issues a request to read preview image data (image data to be previewed) to an image pipe 141d. At this point, since no image data are retained in the image pipe 141d, in step S55, the image pipe 141d transmits this read request to the processing filter 132. In response to reception of this read request, in step S56, the processing filter 132 reads the image data from the image pipe 141c. Then, the processing filter 132 executes the job of processing the read image data, and outputs the processed image data to the image pipe 141d.

Here, the preview filter 136 continues to issue the read request to the image pipe 141d until the preview filter 136 reads preview image data. Accordingly, the processed image data output from the processing filter 132 are read by the preview filter 136 through the image pipe 141d.

When the preview filter 136 has read the processed image data from the image pipe 141d, in step S57, the preview filter 136 executes the process of outputting the image data as preview image data to output a preview image. The preview image data output from the preview filter 136 in step S57 are displayed on a preview UI 113. The preview UI 113 may be implemented by a display member provided to the operations part of the image processor 100A or may be included in the local UI 111. Operations related to preview image settings may be performed in the preview UI 113 in addition to displaying a preview image.

If an instruction is given in the preview UI 113 to execute printing in accordance with the preview image in step S58, in step S59, the preview filter 136 notifies the activity 134 of the end of the previewing. Here, the processing executed in the preview filter 136 corresponds to the job generated in the preview filter 136 based on the instruction from the control layer 120.

In response to the end of the previewing, in step S60, the activity 134 instructs the printing filter 135 to execute printing. In response to reception of this instruction, in step S61, the printing filter 135 issues a request to read image data to be printed to the image pipe 141b. In step S62, the image pipe 141b transmits this read request to the processing filter 132.

In response to reception of this read request, in step S63, the processing filter 132 reads the image data from the image pipe 141a. Then, the processing filter 132 processes the read image data, and outputs the processed image data to the image pipe 141b. Here, the printing filter 135 continues to issue the read request to the image pipe 141b until the printing filter 135 reads image data to be printed. Accordingly, the processed image data output from the processed filter 132 are read by the printing filter 135 through the image pipe 141b.

When the printing filter 135 has read the processed image data from the image pipe 141b, the printing filter 135 executes the process of outputting the image data as image data to be printed, and causes printed image data to be output from the plotter part.

According to the image processor 100A of this embodiment, image data to be output are previewed in the above-described manner.

Next, a description is given of the case of displaying a preview image corresponding to a change in the output setting in the image processor 100A.

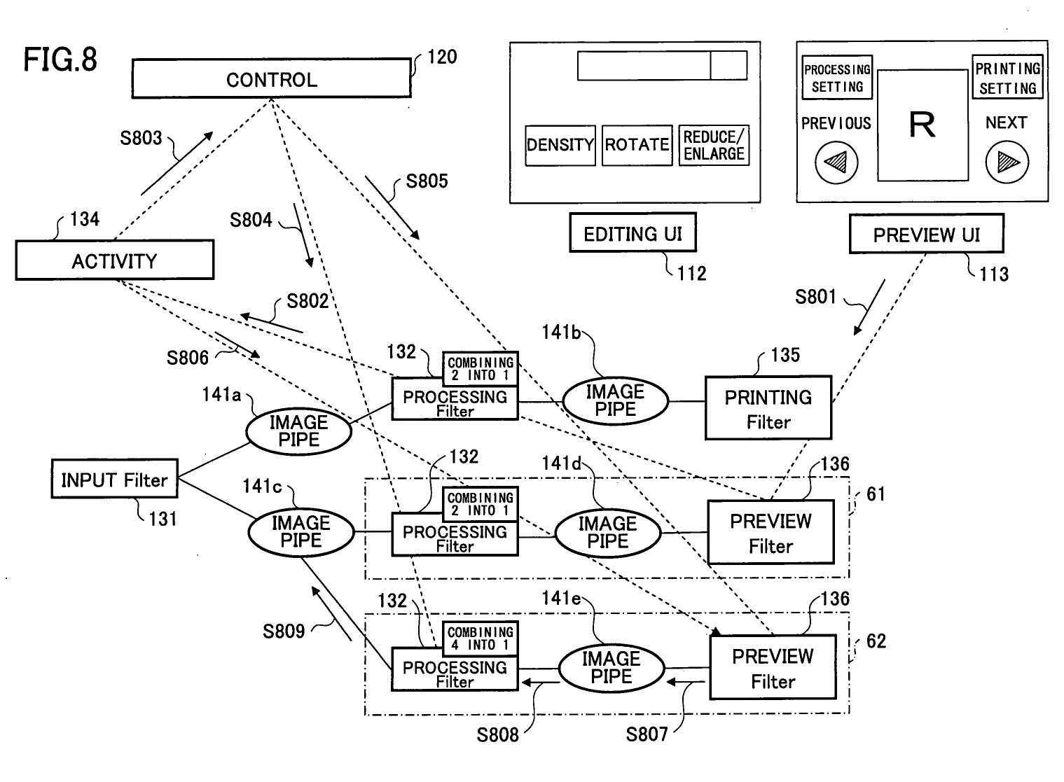

According to the image processor 100A, in response to reception of an instruction to change the output setting and an instruction to perform previewing, the control layer 120 connects the printing filter 135 and the preview filter 136 to the processing filter 132, and connects the processing filter 132 to the image pipe 141c subsequent to the input filter 131. Then, the control layer 120 causes the processing filter 132 and the preview filter 136 to generate jobs corresponding to the changed (updated) output setting (a job line 62 [FIG. 8]).

Further, according to the image processor 100A, the flow of jobs executed in the processing filter 132 and the preview filter 136 in accordance with the output setting is managed as a job line by the activity 134. The job line generated for each output setting is retained in a below-described memory and managed by the activity 134.

According to the image processor 100A of this embodiment, by executing a job line retained in response to a change in the output setting, it is possible to display preview images of multiple patterns, reflecting corresponding output settings therein, as desired without performing control between job lines (between jobs). Therefore, according to the image processor 100A, it is possible to switch and display the preview image for each output setting, so that it is possible to increase the operability of the image processor 100A.

Next, a further description is given below, with reference to FIG. 8, of preview image displaying corresponding to the output setting.

FIG. 8 is a diagram for illustrating previewing corresponding to the output setting.

Here, a description is given of the case where the output setting is changed from a two-page combining setting for combining two pages' worth of image data into a single sheet to a four-page combining setting for combining four pages' worth of image data into a single sheet.

In response to reception of an instruction given in the editing UI 112 to change the output setting and an instruction given in the preview UI 113 to perform previewing after the output setting is changed, the control layer 120 connects the printing filter 135 and the preview filter 136 to the processing filter 132, and connects the processing filter 132 to the image pipe 141c subsequent to the input filter 131. In step S801, the preview UI 113 gives an instruction to perform previewing after the output setting is changed to the preview filter 136.

In step S802, the preview filter 136 notifies the activity 134 of reception of the instruction to perform previewing after the output setting is changed. In response to reception of this notification, in step S803, the activity 134 requests the control layer 120 to generate jobs corresponding to the change in the output setting. In response to reception of the job generation request, the control layer 120 causes the filters 132 and 136 to generate jobs, and determines the jobs as the job line 62.

That is, in step S804, the control layer 120 causes the processing filter 132 to generate a job to subject image data to processing corresponding to the four-page combining setting provided in the editing UI 112. Further, in step S805, the control layer 120 causes the preview filter 126 to generate a job to output preview image data corresponding to the four-page combining setting. Accordingly, the job line 62 corresponds to the four-page combining setting. The job line 62 is stored and retained in a below-described memory. A job line 61 corresponding to the two-page combining setting is retained in the memory.

In response to the generation of the job line 62, in step S806, the activity 134 issues an instruction to execute the job line 62. That is, the activity 134 issues an instruction to execute the jobs of the job line 62 to the preview filter 136.

In response to reception of this execution instruction, in step S807, the preview filter 136 issues a request to read image data to an image pipe 141e. At this point, no image data are retained in the image pipe 141e. Accordingly, in step S808, the image pipe 141e transmits the read request to the processing filter 132. In response to reception of this read request, the processing filter 132 reads image data from the image pipe 141c. Then, the processing filter 132 processes the read image data, and outputs the processed image data to the image pipe 141e.

The preview filter 136 continues to issue the read request to the image pipe 141e until the preview filter 136 reads image data. Accordingly, the processed image data output from the processing filter 132 are read by the preview filter 136 through the image pipe 141e. The preview filter 136 causes the read processed image data to be displayed as a preview image.

Thus, according to the image processor 100A of this embodiment, every time the output setting is changed, jobs to be executed in response to the change in the output setting in the processing filter 132 and the preview filter 136 are generated. The jobs generated in the processing filter 132 and the preview filter 136 are executed as a job line corresponding to the changed (updated) output setting. Further, according to the image processor 100A of this embodiment, a corresponding job line generated is retained for each output setting. Accordingly, if the output setting is changed, it is possible to select and execute a job line corresponding to the changed (updated) output setting.

Therefore, according to the image processor 100A, it is possible to perform previewing reflecting any output setting without performing complicated control such as management of the history of individual operations by a job or management of the consistency in operations history between jobs. Further, according to this embodiment, it is possible to display a preview image corresponding to a past output setting as desired. This makes it unnecessary for a user to memorize past output settings, thus making it possible to increase the operability of the image processor 100A.

Next, a description is given of management of job lines in the image processor 100A.

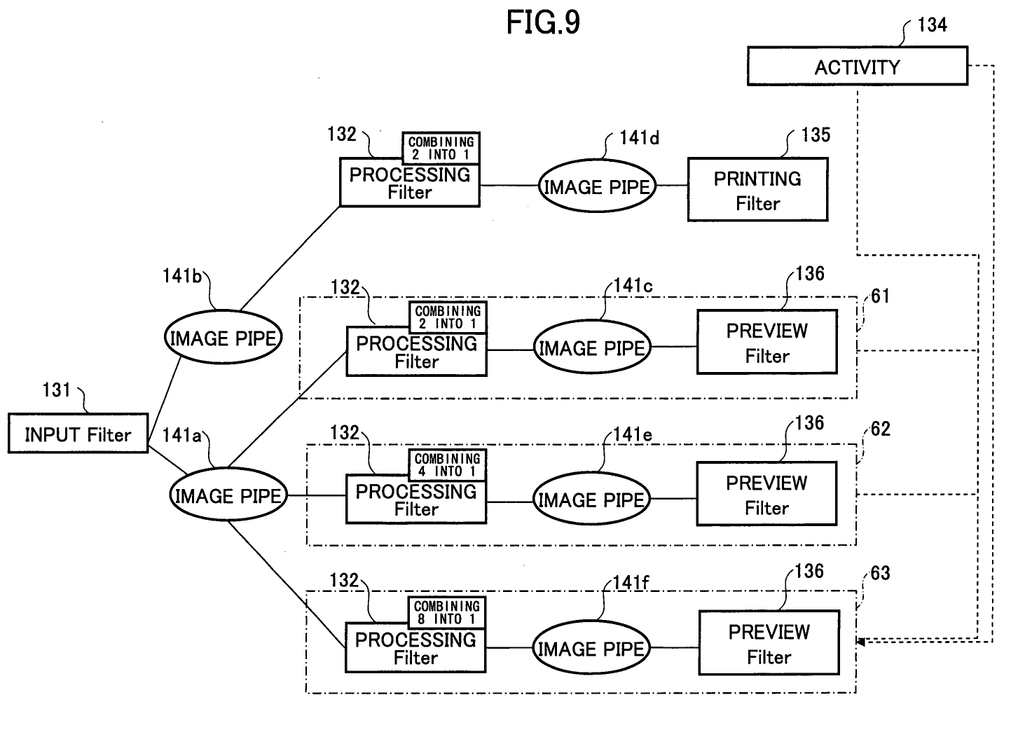

FIG. 9 is a diagram for illustrating management of job lines in the image processor 100A.

In the case illustrated in FIG. 9, three job lines are retained. The job line 61 corresponds to the two-page combining setting for combining two pages' worth of image data into a single sheet. The job line 62 corresponds to the four-page combining setting for combining four pages' worth of image data into a single sheet. A job line 63 corresponds to an eight-page combining setting for combining eight pages' worth of image data into a single sheet. In the job line 63, the processing filter 132 and the preview filter 136 are connected through an image pipe 141f.

These job lines 61 through 63 are generated when their corresponding output settings are provided, and are retained in a memory or the like. For example, the job lines 61 through 63 may be generated and retained when their corresponding output settings are provided for the first time after the image processor 100A is activated. The job lines 61 through 63 may be retained until the output setting is initialized in the image processor 100A. Alternatively, the job lines 61 through 63 may be retained for a predetermined period of time after their generation, and be erased from the memory after passage of the predetermined period of time.

The activity 134 executes a job line corresponding to the output setting provided in the editing UI 112 as an active job line.

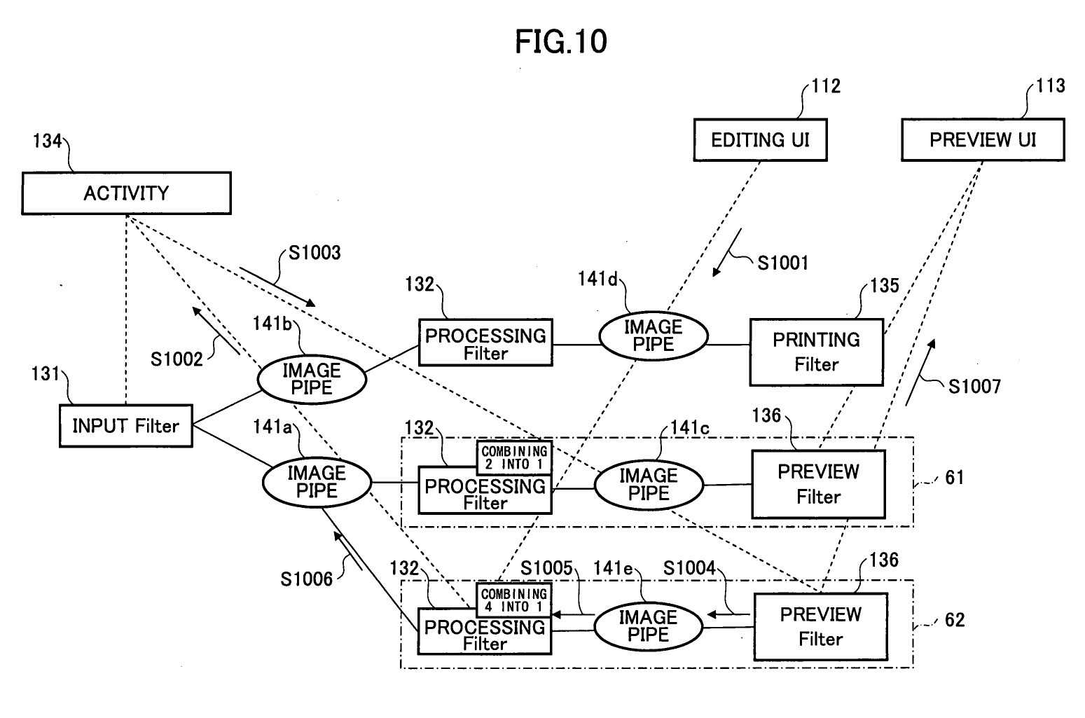

Next, a description is given below, with reference to FIG. 10, of the case of selecting and executing a job line.

FIG. 10 is a diagram for illustrating the case of executing an active job line in the image processor 100A.

When the output setting is changed in the editing UI 112, in step S1001, the editing UI 112 notifies the processing filter 132 of reception of an instruction to change the output setting. FIG. 10 shows the case of changing the output setting from the two-page combining setting to the four-page combining setting.

In response to reception of the output setting change instruction, in step S1002, the processing filter 132 transmits the output setting change instruction to the activity 134. In step S1003, from retained job lines, the activity 134 selects the job line 62 corresponding to the four-page combining setting, to which the output setting has been changed, as an active job line, and gives an instruction to execute the job line 62. That is, the activity 134 gives the preview filter 136 an instruction to execute the jobs of the job line 62.

In response to reception of the job execution instruction, in step S1004, the preview filter 136 issues a request to read image data to the image pipe 141e. In step S1005, the image pipe 141e transmits this request to the processing filter 132. In response to reception of this request, in step S1006, the processing filter 132 executes the job of reading image data from the image pipe 141a and processing the image data, and outputs the processed image data. In response to the outputting of the processed image data from the processing filter 132, in step S1007, the preview filter 136 reads the output processed image data through the image pipe 141e, and causes the processed image data to be displayed as a preview image.

According to the image processor 100A of this embodiment, an active job line is selected from retained job lines and executed in this manner.

According to the image processor 100A of this embodiment, it is possible to implement a preview display reversing function and a preview display forwarding function with the above-described configuration of retaining a job line for each output setting and selecting and executing an active job line.

A description is given below of the preview display reversing function and the preview display forwarding function.

The preview display reversing function returns a preview display at one point to a preview display reflecting the immediately preceding output setting. The preview display forwarding function switches a preview display at one point to a preview display reflecting the next output setting provided.

In other words, the preview display reversing function switches preview display from a preview image reflecting an output setting at one point to a preview image reflecting the output setting immediately before the output setting at that point. Further, the preview display forwarding function switches preview display from a preview image reflecting an output setting at one point to a preview image reflecting the output setting provided immediately after the output setting at that point.

The image processor 100A switches preview display in response to reception of a REVERSE instruction that is an instruction to execute the preview display reversing function or in response to reception of a FORWARD instruction that is an instruction to execute the preview display forwarding function.

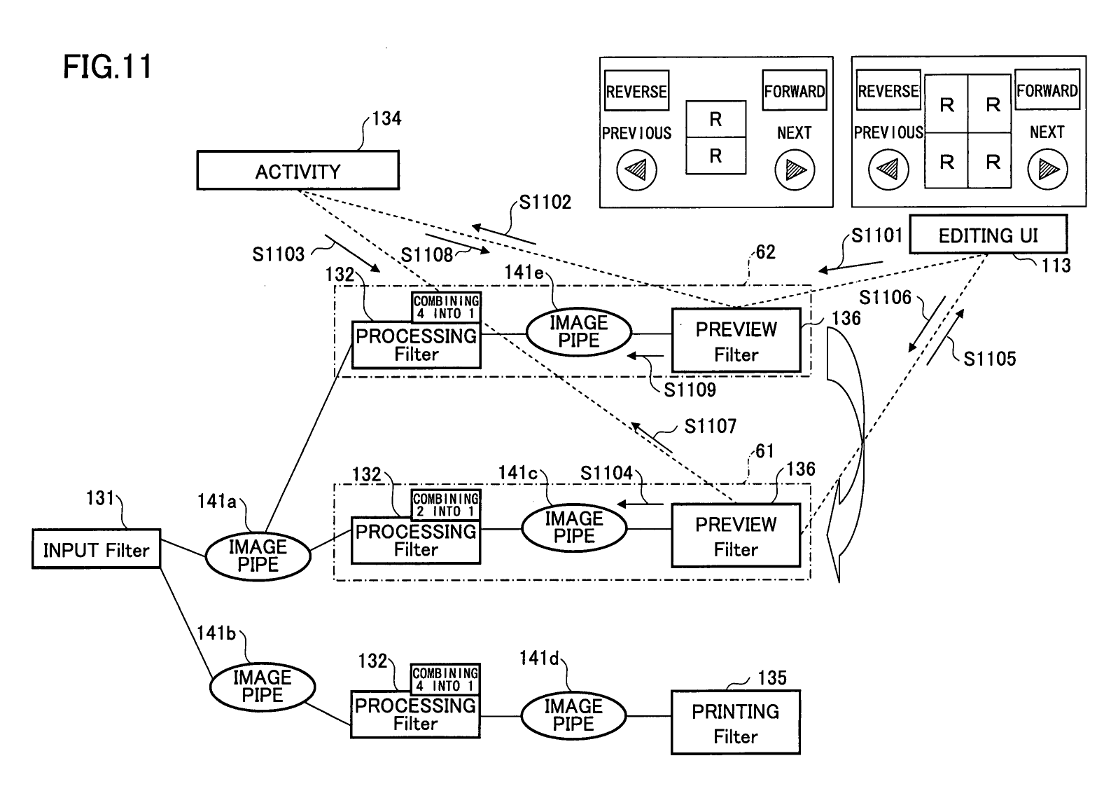

A description is given below, with reference to FIG. 11, of preview display switching.

FIG. 11 is a diagram for illustrating preview image switching in the image processor 100A.

In the case of FIG. 11, the output setting is the four-page combining setting, and the current active job line is the job line 62 corresponding to the four-page combining setting. Accordingly, a preview image corresponding to the four-page combining setting is displayed on the preview UI 113.

In response to reception of a REVERSE instruction, in step S1101, the preview UI 113 notifies the preview filter 136 of the reception of the REVERSE instruction. In step S1102, the preview filter 136 notifies the activity 134 of the reception of the REVERSE instruction.

In response to reception of the REVERSE instruction, the activity 134 selects a job line generated immediately before the job line 62 from retained job lines. In the case of FIG. 11, the job line 61 is assumed to have been generated immediately before the job line 62 and retained.

In step S1103, the activity 134 selects and executes the job line 61. That is, the activity 134 gives the preview filter 136 an instruction to execute the jobs of the job line 61. In step S1104, the preview filter 136 transmits the instruction to execute the jobs of the job line 61 to the processing filter 132 through the image pipe 141c. In response to reception of the job execution instruction, the processing filter 132 executes a job selected from the jobs retained in a memory. The job selected here corresponds to the two-page combining setting.

When the job is executed in the processing filter 132, processed image data are output to the image pipe 141c. The preview filter 136 reads the processed image data from the image pipe 141c, and in step S1105, executes the job of outputting the processed image data as a preview image to cause the preview UI 113 to display the preview image. The preview image displayed here is of the two-page combining setting, which is an output setting to which the job line 61 corresponds.

In response to reception of a FORWARD instruction, in step S1106, the preview UI 113 notifies the preview filter 136 of the reception of the FORWARD instruction. In step S1107, the preview filter 136 notifies the activity 134 of the reception of the FORWARD instruction.

In response to reception of the FORWARD instruction, in step S1108, the activity 134 selects the job line 62 executed before the REVERSE instruction from retained job lines, and executes the job line 62. That is, the activity 134 gives the preview filter 136 an instruction to execute the jobs of the job line 62. In step S1109, the preview filter 136 transmits the instruction to execute the jobs of the job line 62 to the processing filter 132 through the image pipe 141e. In response to reception of the job execution instruction, the processing filter 132 executes a job selected from the jobs retained in the memory. The job selected here corresponds to the four-page combining setting.

When the job is executed in the processing filter 132, processed image data are output. The preview filter 136 reads the processed image data through the image pipe 141e, and causes the processed image data to be displayed as a preview image.

According to the image processor 100A of this embodiment, the preview display reversing function and the preview display forward function are thus implemented. The preview display reversing function enables the image processor 100A to display a preview image reflecting an immediately preceding output setting. Further, the preview display forwarding function enables the image processor 100A to return a first preview display to a second preview display that has been switched to the first preview display based on a REVERSE instruction. This makes it unnecessary for a user to memorize past output settings, thus making it possible for the user to easily compare a preview image reflecting a current output setting and a preview image reflecting a past output setting. Therefore, according to this embodiment, it is possible to increase the operability of the image processor 100A.

Further, according to the image processor 100A of this embodiment, if an instruction to change the output setting other than the FORWARD instruction is given after the preview display is switched in response to the REVERSE instruction, the job line executed immediately before the REVERSE instruction is replaced with a job line generated in correspondence to the output setting changed (updated) after the REVERSE instruction.

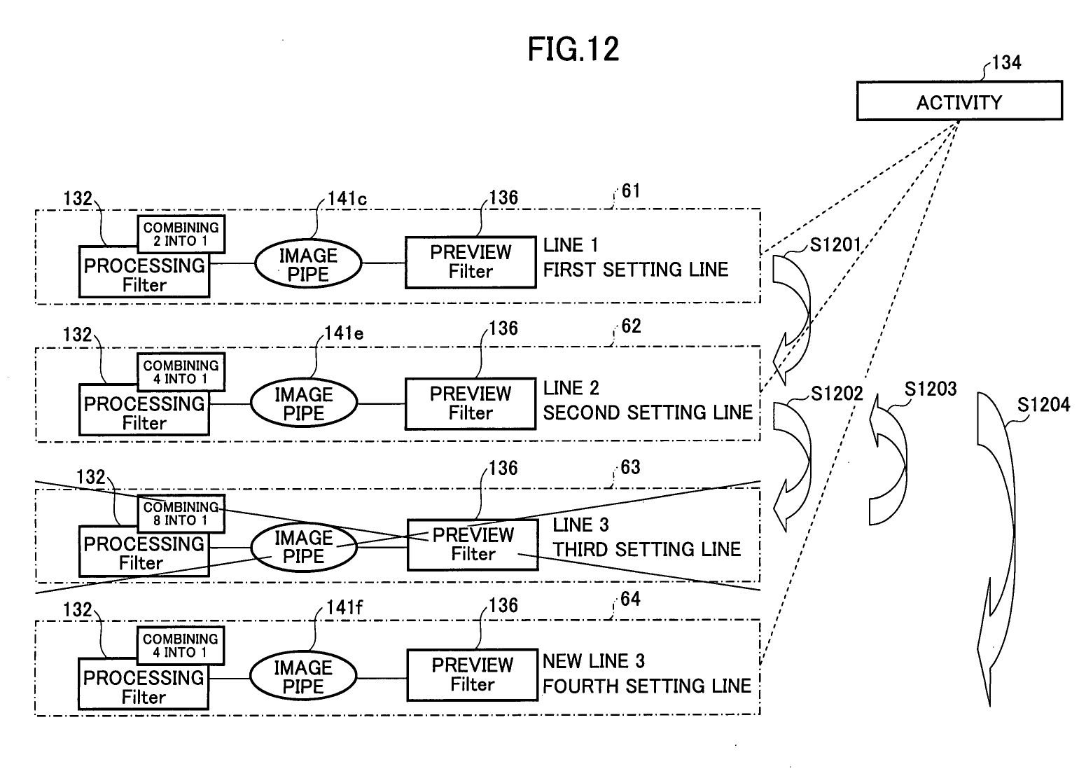

A description is given below, with reference to FIG. 12, of changing the output setting after a REVERSE instruction.

FIG. 12 is a diagram for illustrating the case where the output setting is changed after a REVERSE instruction in the image processor 100A.

In the case of FIG. 12, the output setting is the two-page combining setting and the active job line is the job line 61 in the image processor 100A. Here, if the output setting is changed from the two-page combining setting to the four-page combining setting, in step S1201, the activity 134 generates and executes the job line 62 corresponding to the four-page combining setting. Further, the activity 134 causes the job line 62 to be stored and retained in a memory.

If the output setting is further changed from the four-page combining setting to the eight-page combining setting in the image processor 100A, in step S1202, the activity 134 generates and executes the job line 63 corresponding to the eight-page combining setting. Further, the activity 134 causes the job line 63 to be stored and retained in the memory.

Here, if a REVERSE instruction is given in the preview UI 113, in step S1203, the activity 134 selects and executes the job line 62 executed immediately before the job line 63. Here, the preview image displayed on the preview UI 113 is switched from a preview image corresponding to the eight-page combining setting to a preview image corresponding to the four-page combining setting.

If the output setting is further changed after the preview image is switched, in step S1204, the control layer 120 generates a job line 64 corresponding to the changed (updated) output setting. The activity 134 overwrites (replaces) the job line 63 with the job line 64, and stores the job line 64 in the memory. For example, if the output setting is changed to a duplex printing setting in the editing UI 112 after the REVERSE instruction, the control layer 120 generates the job line 64 corresponding to the duplex printing setting. The activity 134 retains the generated job line 64 by updating (replacing) the job line 63 with the job line 64.

According to the image processor 100A of this embodiment, this processing makes it possible to provide another output setting based on an output setting at any point of time in the past.

Further, according to the image processor 100A of this embodiment, the processed image data output to an image pipe subsequent to the processing filter 132 may be retained in the case of executing a job line generated in correspondence to the output setting.

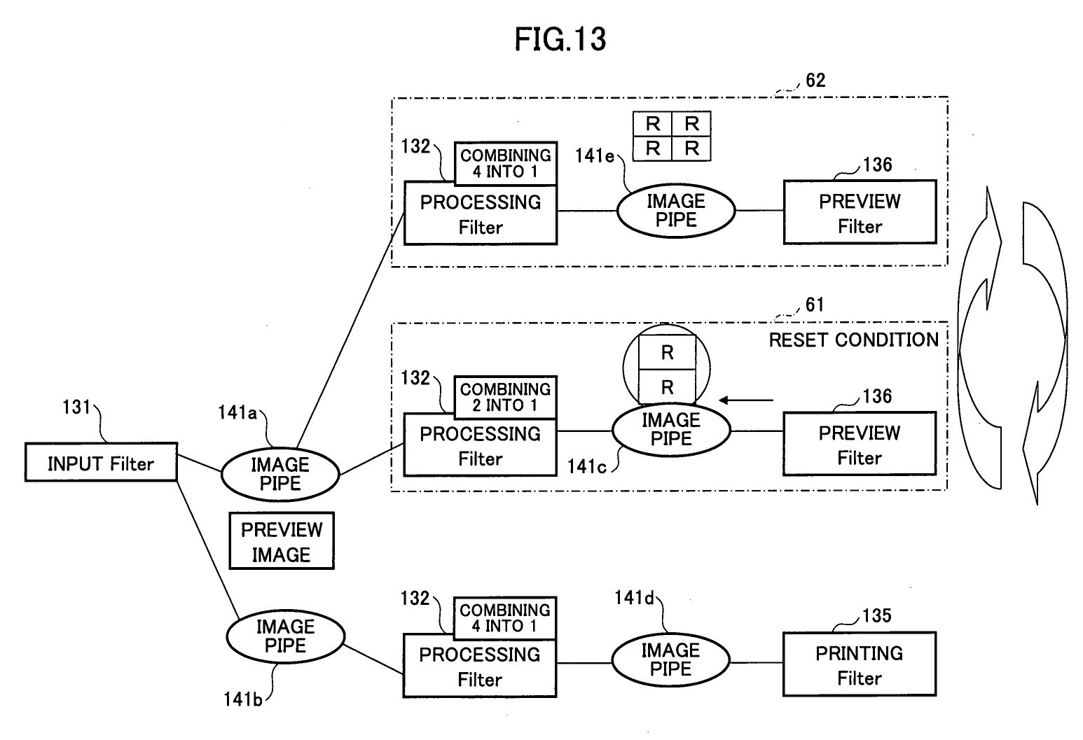

A description is given below, with reference to FIG. 13, of the case of retaining processed image data.

FIG. 13 is a diagram for illustrating the case of retaining image data in an image pipe subsequent to the processing filter 132.

For example, if the job line 61 is executed in the image processor 100A, the processed image data output from the processing filter 132 to the image pipe 141c correspond to the two-page combining setting. The processed image data are retained in the image pipe 141c.

According to this configuration, if the job line 61 is selected after execution of the job line 62, it is possible to display a preview image corresponding to the job line 61 only with execution of a job by the preview filter 136.

If the activity 134 reselects the job line 61, the preview filter 136 receives an instruction to execute the job line 61 from the activity 134. In response to the reception of the execution instruction, the preview filter 136 reads image data from the image pipe 141c. At this point, processed image data that are a result of execution of the job forming the job line 61 in the processing filter 132 have been retained in the image pipe 141c. Accordingly, it is possible to cause the image data to be displayed as a preview image only by the preview filter 136 reading the processed image data from the image pipe 141c.

Therefore, according to the image processor 100A of this embodiment, it is possible to increase the performance of preview display switching in the case where the output setting is changed, so that it is possible to reduce processing load in the processing filter 132.

Further, according to the image processor 100A of this embodiment, a preview image before the change of the output setting and a preview image after the change of the output setting may be simultaneously displayed on the operations part. It is assumed that the operations part of the image processor 100A is implemented with, for example, a member having a display function, such as an operations panel.

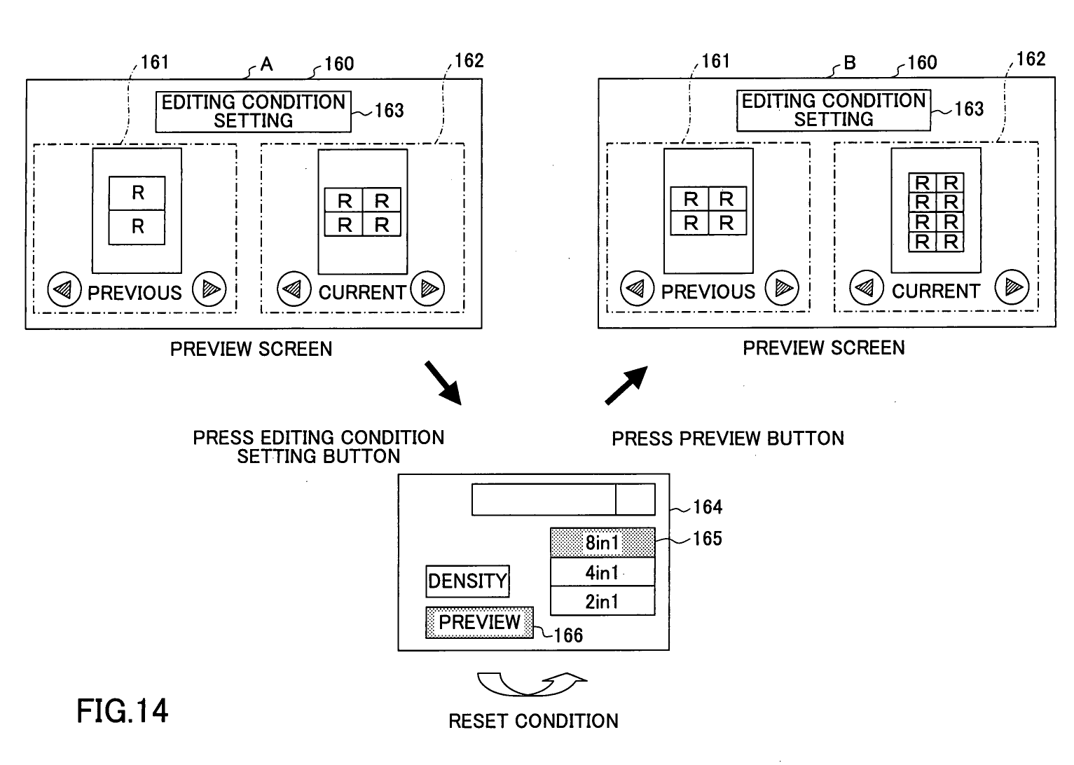

FIG. 14 is a diagram showing the case where preview images before and after the change of the output setting are displayed in the operations part of the image processor 100A.

Referring to FIG. 14, an operations part 160 includes a display area 161 where a preview image before the change of the output setting is displayed and a display area 162 where a preview image after the change of the output setting is displayed, and the display area 161 and the display area 162 are simultaneously displayed. In the operations part 160, a preview image reflecting a current output setting is displayed in the display area 162, and a preview image reflecting a past output setting is displayed in the display area 161.

Referring to FIG. 14, when the display state of the operations part 160 is State A, a preview image corresponding to the current output setting, which is the four-page combining setting, is displayed in the display area 162. Here, if an editing condition setting button 163 is pressed in the operations part 160, an editing setting screen 164 is displayed. If the current output setting is changed to the eight-page combining setting by pressing a corresponding setting button 165 and then a PREVIEW button 166 on the editing setting screen 164, the display state of the operations part 160 make a transition to State B. In State B, the preview image displayed in the display area 162 in State A is displayed in the display area 161 as the preview image before the change of the output setting. The preview image of the newly-provided eight-page combining setting is displayed in the display area 162 as a preview image reflecting the current output setting.

Thus, according to the image processor 100A of this embodiment, the preview images before and after the change of the output setting are simultaneously displayed, so that it is unnecessary for a user to memorize past output settings. Further, according to the image processor 100A, it is possible for a user to visually compare current and past output settings. Accordingly, it is possible to increase the operability of the image processor 100A.

The procedures for implementing one or more of the functions in the above-described embodiments may be recorded in a recording medium as a computer-readable program.

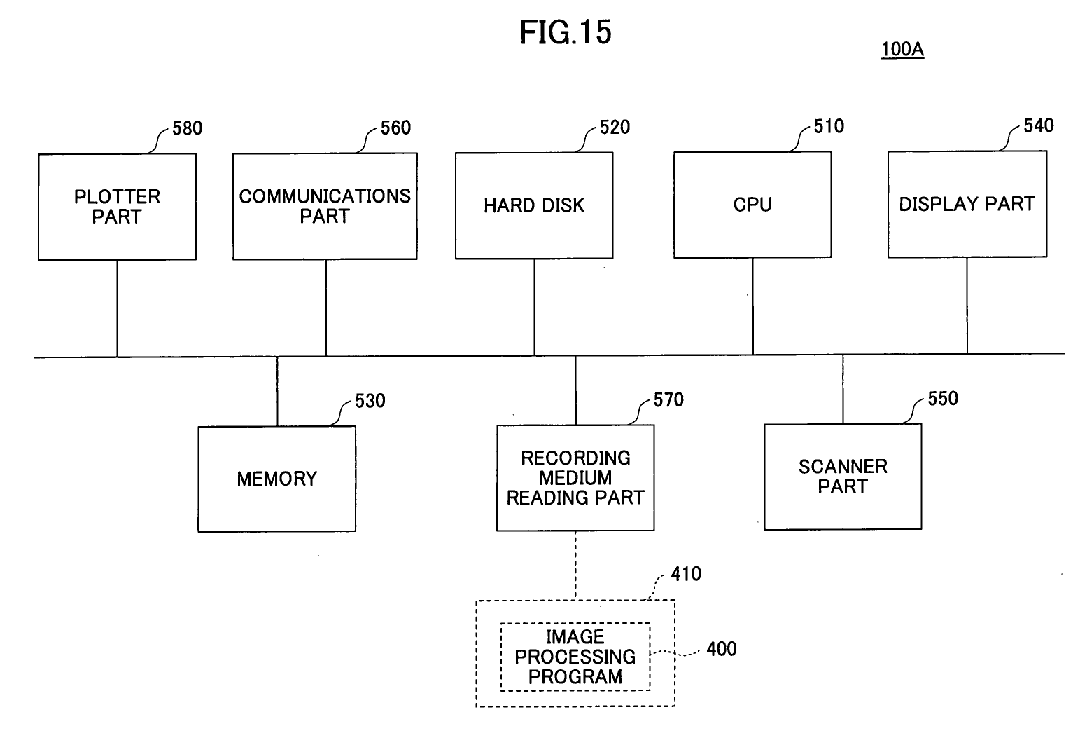

FIG. 15 is a diagram for illustrating a recording medium on which is recorded a program for causing one or more of the functions described in the above-described embodiments to be implemented.

A program 400 such as an image processing program recorded on a recording medium 410 is read into a central processing unit (CPU) 510 of an image processor 500 and executed, so that one or more of the functions described in each of the above-described embodiments can be implemented. The image processor 500 is capable of implementing the functions of the image processor 100 of the first embodiment and functions of the image processor 100A of the second embodiment.

For example, the image processor 500 includes the CPU 510, a hard disk 520, a memory 530, a display part 540, a scanner part 550, a communications part 560, a recording medium reading part 570, and a plotter part 580. The CPU 510 is a processing unit and executes arithmetic or other operations performed in the image processor 500. The hard disk 520 is a recording part to store data. Applications that operate on the image processor 500 and data created by the applications are stored in the hard disk 520.

Various set values related to the image processor 500 and the results of operations in the CPU 510 are stored in the memory 530. Further, the memory 530 is a retention part where the jobs forming job lines generated in correspondence to output settings are stored and retained.

The display part 540 is, for example, a display. The apparatus information of the image processor 500 and information related to the progress of processing in the image processor 500 are displayed on the display part 540 in such a manner as to be readable by a user. The scanner part 550 includes a scanning part and a scanner engine that controls the scanning part. Paper original material such as a paper document is scanned by the scanner part 550 to be input as electronic image data. The communications part 560 is, for example, a network control unit. The image processor 500 communicates with external apparatuses through the communications part 560. The recording medium reading part 570 reads data and programs recorded on various recording media, and is, for example, a floppy disk driver. The plotter part 580 includes a plotter and a plotter engine that controls the plotter, and prints out various image data.

The image processing program 400 that implements one or more of the functions of the above-described embodiments is recorded on the recording medium 410. The image processing program 400 is read by the recording medium reading part 570 to be executed in the CPU 510. The recording medium 410 may be any medium such as a memory card or a floppy (registered trademark) disk as long as it is readable in the image processor 500. Alternatively, the image processing program 400 may also be received by the communications part 560 through a network such as a LAN or the Internet to be stored in the hard disk 520.

The present invention is employable in image processors to which the concept of pipes and filters is applied.

Thus, according to one embodiment of the present invention, an image processor is provided that includes an input part to which image data to be subjected to image processing are input; an input filter configured to control the inputting of the image data to the input part; an output part configured to output the result of the image processing; an output filter configured to control the outputting of the image data from the output part; and a processing filter configured to control processing of the image data, the processing filter being to be connected between the input filter and the output filter through multiple pipes, wherein the processing filter is connected to one of the pipes which one pipe is subsequent to the input filter when the output setting of the image data output from the output part is changed (Configuration 1).

According to Configuration 1, it is possible to simplify customization or expansion of a function.

Additionally, the image processor as set forth in Configuration 1, may further include a preview filter configured to control outputting of the preview image data of the image data output from the output part, wherein the processing filter may be connected to the one of the pipes which one pipe is subsequent to the input filter and the output filter and the preview filter may be connected to the processing filter through corresponding ones of the pipes when the output setting of the image data output from the output part is changed (Configuration 2).

According to Configuration 2, it is possible to simplify customization or expansion of a function and to implement a preview function without changing existing components.

Additionally, the image processor as set forth in Configuration 2, may further include a retention part configured to retain jobs to be executed in the processing filter and the preview filter, the jobs being generated in the processing filter and the preview filter on an output setting basis; and a management part configured to manage execution of the jobs, wherein the management part may be configured to cause the processing filter and the preview filter to execute jobs corresponding to the changed output setting (Configuration 3).

According to Configuration 3, it is possible to switch the preview image for each output setting without performing complicated control between jobs in each filter.

Additionally, in the image processor as set forth in Configuration 3, the management part may be configured to, in response to reception of an instruction to return the output setting to a previous state, cause the processing filter and the preview filter to execute jobs corresponding to a preceding output setting immediately preceding the output setting at a time of the reception of the instruction (Configuration 4).

According to Configuration 4, it is unnecessary for a user to memorize an output setting provided (determined) by the user, and it is possible to easily obtain a preview image reflecting a past output setting.

Additionally, in the image processor as set forth in Configuration 4, the management part may be configure to, when the output setting is changed after the reception of the instruction, replace the jobs corresponding to the preceding output setting with jobs corresponding to the output setting changed after receiving the instruction (Configuration 5).

According to Configuration 5, it is possible to set a new output setting at any past point in time.

Additionally, in the image processor as set forth in Configuration 2, when the output setting is changed, the image data output from the processing filter in the output setting before the change are retained in one of the pipes which one pipe is subsequent to the processing control part (Configuration 6).

According to Configuration 6, it is unnecessary to reprocess image data when the output setting is returned to the one before the change, so that it is possible to reduce a processing load in the processing filter.

Additionally, the image processor as set forth in Configuration 2 may further include an operations part in which an operation related to the image processor is performed, the operations part including a first area in which a first preview image before the change of the output setting and a second area in which a second preview image after the change of the output setting (Configuration 7).

According to Configuration 7, it is possible to visually compare the preview images before and after the change of the output setting, so that it is possible to increase the operability of the image processor.

According to one embodiment of the present invention, an image processing method is provided that includes the steps of (a) controlling inputting of image data to be subjected to image processing to an input part; (b) controlling outputting of the image data from an output part configured to output the result of the image processing; and (c) controlling processing of the image data, wherein step (c) is performed between step (a) and step (b) when the output setting of the image data output from the output part is changed (Configuration 8).

According to Configuration 8, it is possible to simplify customization or expansion of a function.

According to one embodiment of the present invention, a computer-readable recording medium is provided on which is recorded a program for causing a computer to execute the image processing method as set forth in Configuration 8 (Configuration 9).

According to Configuration 9, it is possible to simplify customization or expansion of a function.

The present invention is not limited to the specifically disclosed embodiments, and variations and modifications may be made without departing from the scope of the present invention.

The present application is based on Japanese Priority Patent Application No. 2007-129697, filed on May 15, 2007, the entire contents of which are hereby incorporated by reference.

What is claimed is:

1. An image processor, comprising:
an input part to which image data to be subjected to image processing are input;
an input control part configured to control the inputting of the image data to the input part;
an output part configured to output a result of the image processing;
an output control part configured to control the outputting of the image data from the output part; and
a processing control part configured to control processing of the image data, the processing control part being to be connected between the input control part and the output control part through a plurality of transmission parts,
wherein the processing control part is connected to one of the transmission parts which one transmission part is subsequent to the input control part when an output setting of the image data output from the output part is changed.

2. The image processor as claimed in claim 1, further comprising:
a preview control part configured to control outputting of preview image data of the image data output from the output part,
wherein the processing control part is connected to the one of the transmission parts which one transmission part is subsequent to the input control part and the output control part and the preview control part are connected to the processing control part through corresponding ones of the transmission parts when the output setting of the image data output from the output part is changed.

3. The image processor as claimed in claim 2, further comprising:
a retention part configured to retain jobs to be executed in the processing control part and the preview control part, the jobs being generated in the processing control part and the preview control part on an output setting basis; and
a management part configured to manage execution of the jobs,
wherein the management part is configured to cause the processing control part and the preview control part to execute jobs corresponding to the changed output setting.

4. The image processor as claimed in claim 3, wherein the management part is configured to, in response to reception of an instruction to return the output setting to a previous state, cause the processing control part and the preview control part to execute jobs corresponding to a preceding output setting immediately preceding the output setting at a time of the reception of the instruction.

5. The image processor as claimed in claim 4, wherein the management part is configured to, when the output setting is changed after the reception of the instruction, replace the jobs corresponding to the preceding output setting with jobs corresponding to the output setting changed after receiving the instruction.

6. The image processor as claimed in claim 2, wherein when the output setting is changed, the image data output from the processing control part in the output setting before the change are retained in one of the transmission parts which one transmission part is subsequent to the processing control part.

7. The image processor as claimed in claim 2, further comprising:
an operations part in which an operation related to the image processor is performed, the operations part including a first area in which a first preview image before the change of the output setting and a second area in which a second preview image after the change of the output setting.

8. An image processor, comprising:
an input part to which image data to be subjected to image processing are input;
input control means for controlling the inputting of the image data to the input part;
an output part configured to output a result of the image processing;
output control means for controlling the outputting of the image data from the output part; and
processing control means for controlling processing of the image data, the processing control means being to be connected between the input control means and the output control means through transmission means,
wherein the processing control means is connected to one of the transmission means which one transmission means is subsequent to the input control means when an output setting of the image data output from the output part is changed.

9. The image processor as claimed in claim 8, further comprising:
preview control means for controlling outputting of preview image data of the image data output from the output part,
wherein the processing control means is connected to the one of the transmission means which one transmission means is subsequent to the input control means and the output control means and the preview control means are connected to the processing control means through corresponding ones of the transmission means when the output setting of the image data output from the output part is changed.

10. The image processor as claimed in claim 9, further comprising:
a retention part configured to retain jobs to be executed in the processing control means and the preview control means, the jobs being generated in the processing control means and the preview control means on an output setting basis; and
management means for managing execution of the jobs,
wherein the management means causes the processing control means and the preview control means to execute jobs corresponding to the changed output setting.

11. The image processor as claimed in claim 10, wherein in response to reception of an instruction to return the output setting to a previous state, the management means causes the processing control means and the preview control means to execute jobs corresponding to a preceding output setting immediately preceding the output setting at a time of the reception of the instruction.

12. The image processor as claimed in claim 11, wherein when the output setting is changed after the reception of the instruction, the management means replaces the jobs corresponding to the preceding output setting with jobs corresponding to the output setting changed after receiving the instruction.

13. The image processor as claimed in claim 9, wherein when the output setting is changed, the image data output from the processing control means in the output setting before the change are retained in one of the transmission means which one transmission means is subsequent to the processing control part.

14. The image processor as claimed in claim 9, further comprising:
an operations part in which an operation related to the image processor is performed, the operations part including a first area in which a first preview image before the change of the output setting and a second area in which a second preview image after the change of the output setting.

15. An image processing method, comprising the steps of:
(a) controlling inputting of image data to be subjected to image processing to an input part;
(b) controlling outputting of the image data from an output part configured to output a result of the image processing; and
(c) controlling processing of the image data,
wherein said step (c) is performed between said step (a) and said step (b) when an output setting of the image data output from the output part is changed.
